(19) United States
(12) Patent Application Publication
(10) Pub. No.: US 2015/0143737 A1
(43) Pub. Date: May 28, 2015

(54) FISHING JIG

(71) Applicant: Jeffrey O. Boutin, Mequon, WI (US)

(72) Inventor: Jeffrey O. Boutin, Mequon, WI (US)

(21) Appl. No.: 14/088,264

(22) Filed: Nov. 22, 2013

(51) Int. Cl. A01K 85/16; A01K 85/01

(52) U.S. Cl. CPC A01K 85/16; A01K 85/01
USPC 43/42.06

(57) ABSTRACT

An improved fishing jig with a front end having an opening to permit water to enter a hollow shaft running into a body of the jig. One or more side openings may permit water entering the hollow shaft through the opening in the front end to exit the hollow shaft through a side of the body.

### CROSS-REFERENCE TO RELATED APPLICATION

The present application claims priority to U.S. Provisional Application Ser. No. 61/729,372, filed on Nov. 22, 2012, the disclosure of which is incorporated herein by reference in its entirety.

### BACKGROUND

Conventional fishing jigs typically consist of a weighted head molded about or otherwise fastened to the shank of a hook. Typically, a body or skirt of some sort may be fastened about the hook to provide the illusion of a larger prey animal or fish. The body or skirt may be flexible and configured to move with about as the jig passes through the water.

Improvements to conventional jigs are desirable to allow for better flow of water about the body or through the head of the jig to improve the movement or motion of a lure including the jig and enhance the ability of the lure to attract fish.

### BRIEF DESCRIPTION OF THE DRAWINGS

The accompanying drawing figures, which are incorporated in and constitute a part of the description, illustrate several aspects of the present disclosure and together with the description, serve to explain the principles of the present disclosure. A brief description of the figures is as follows:

FIG. 1 is a perspective view of a first embodiment of an improved fishing jig according to the present disclosure.

FIG. 2 is a side view of the improved fishing jig of FIG. 1.

FIG. 3 is a top view of the improved fishing jig of FIG. 1.

FIG. 4 is a front view of the improved fishing jig of FIG. 1.

FIG. 5 is a perspective view of a second alternative embodiment of an improved fishing jig according to the present disclosure.

FIG. 6 is a side view of the improved fishing jig of FIG. 5.

FIG. 7 is a top view of the improved fishing jig of FIG. 5.

FIG. 8 is a front view of the improved fishing jig of FIG. 5.

FIG. 9 is a rear view of the improved fishing jig of FIG. 5.

FIG. 10 is a perspective view of a third alternative embodiment of an improved fishing jig according to the present disclosure.

FIG. 11 is a top view of the improved fishing jig of FIG. 10.

FIG. 12 is a front view of the improved fishing jig of FIG. 10.

FIG. 13 is a rear view of the improved fishing jig of FIG. 10.

### DETAILED DESCRIPTION

Reference will now be made in detail to exemplary aspects of the present disclosure which are illustrated in the accompanying drawings. Wherever possible, the same reference numbers will be used throughout the drawings to refer to the same or like parts.

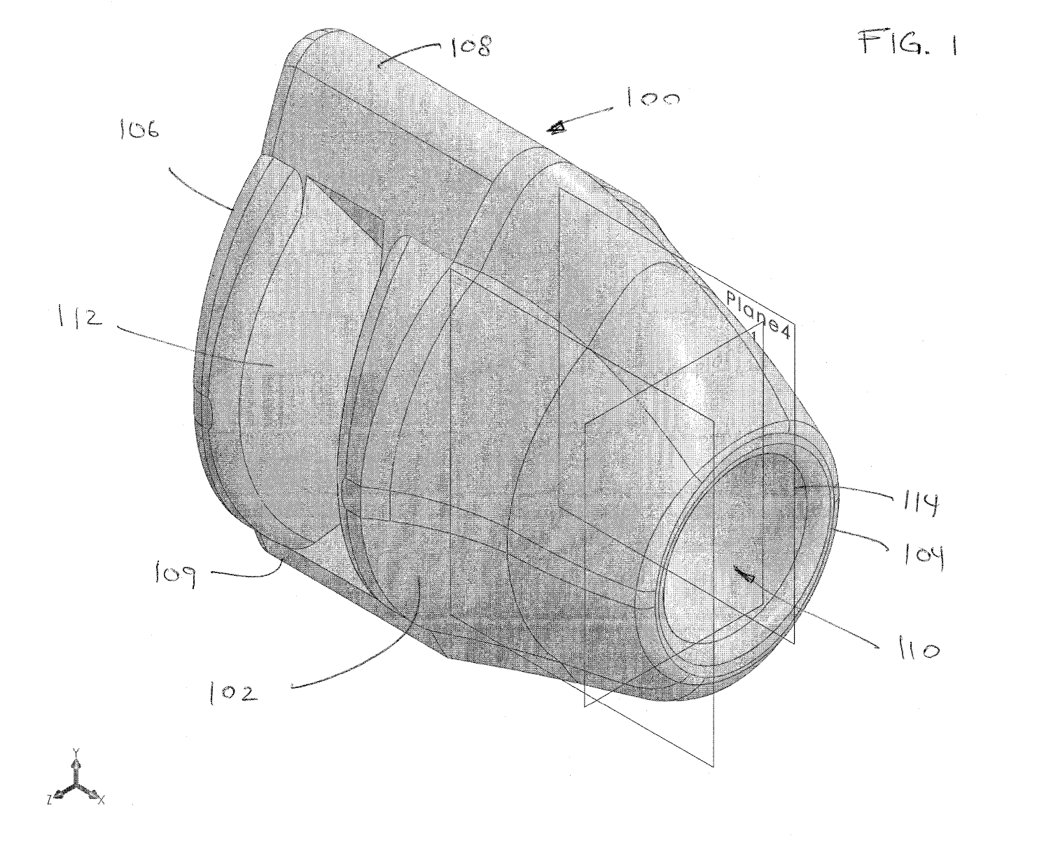

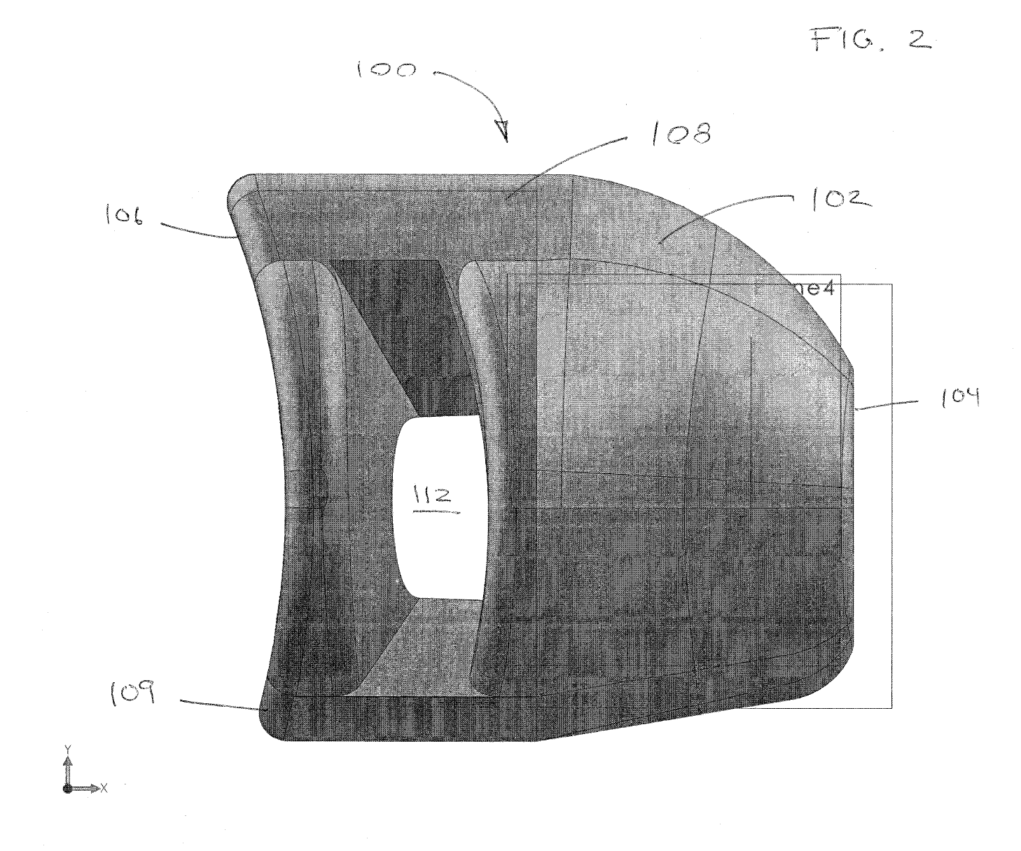

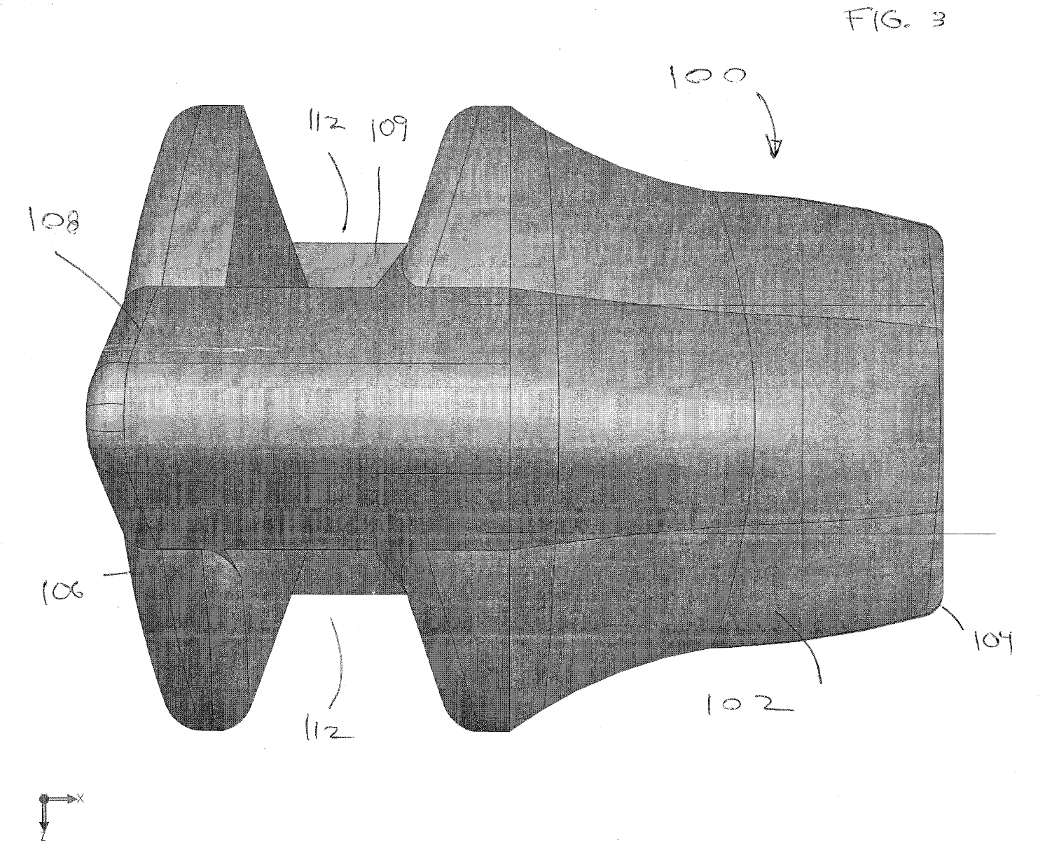

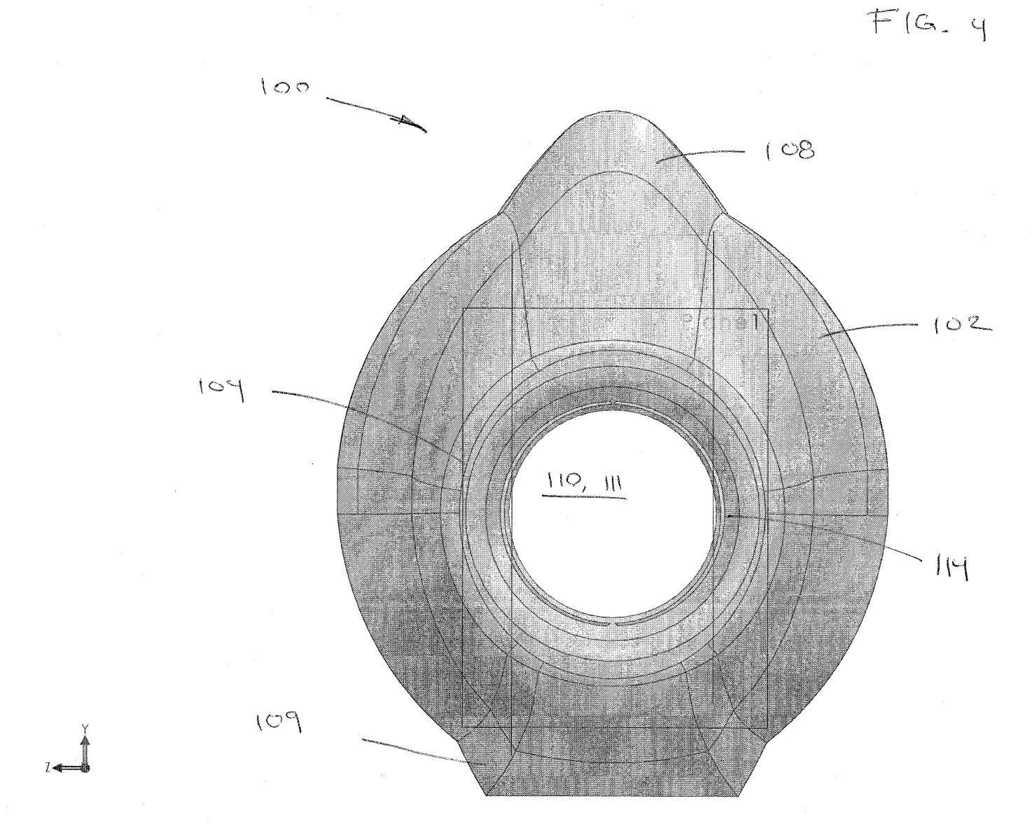

Referring now to FIGS. 1 to 4, an improved fishing jig 100 according the present disclosure may include a body 102 with a front end 104 and a rear end 106. An upper ridge 108 may provide a location for a hook to pass through body 102. The hook and jig 100 may be configured to permit the hook to be passed though body 102 after body 102 has been formed or body 102 may be formed about the hook during a manufacturing process. It is anticipated that body 102 may be formed more symmetrically and not include upper ridge 108 or any other enlarged portion specially adapted to receive the hook. Depending on the size of body 102 and the nature of the material used to form body 102, there may or may not be a need to create an enlarged portion to provide for appropriate strength against the hook possibly pulling through the body during normal use.

It is anticipated that a hook eye for attaching jig 100 to a fishing line may extend from the body, such as through upper ridge 108. With the weight of the jig below the hook eye, jig 100 will tend to hang down from the hook eye and any line attached to the hook eye. To further enhance how jig 100 may hang during use, an additional weighted keel 109 may be formed opposite from upper ridge 108. The upper ridge and keel may cooperate and be sized to encourage or enhance a particular attitude of jig 100 as the jig is moved through the water. As with upper ridge 108, the inclusion of keel 109 is not necessary to the essential characteristics of improved fishing jigs according to the present disclosure. It is anticipated that jig 100 may be molded as a single piece or may be constructed or assembled from two or more pieces.

Beginning at an opening 114 in front end 104 and extending toward rear end 106 may be an open shaft 110 to permit water to flow through body 102. Jig 100 includes an opening 111 through rear end 106 so that water can flow from the front through the rear of the jig, as well as a pair of opposing side openings 112 extending from shaft 110. The size and shape of side openings 112 may be adapted as appropriate to adapt the movement of the jig through the water during use. The size and shape of rear opening 111 may also be adapted in cooperation with side openings 112 to further adapt the movement of the jig as well as possible the flow of water through the jig and across any sort of skirt or other flexible or movable extension added to jig 100 adjacent rear end 106.

Within shaft 110 may be positioned a material that releases a scent or smell into the water as the jig is used for fishing. The material may be a natural item, such as a piece of pork rind or similar material that is durable when exposed to water and which possesses enough scent producing ability to generate scent for longer time while the jig is being used. It would be preferable to have a scent producing element that is capable of lasting through a normal day of fishing as opposed to a scent material that has to be renewed frequently. Alternatively, the material may be synthetic item that is configured to hold and release scent. The material within shaft 110 may be renewable with scent so that jig 100 may be reused and maintain the desired scent. The number of side openings and the nature of the rear opening of the shaft may be selected based on the scent material placed in the shaft or the nature of the scent desired to be released, among other considerations.

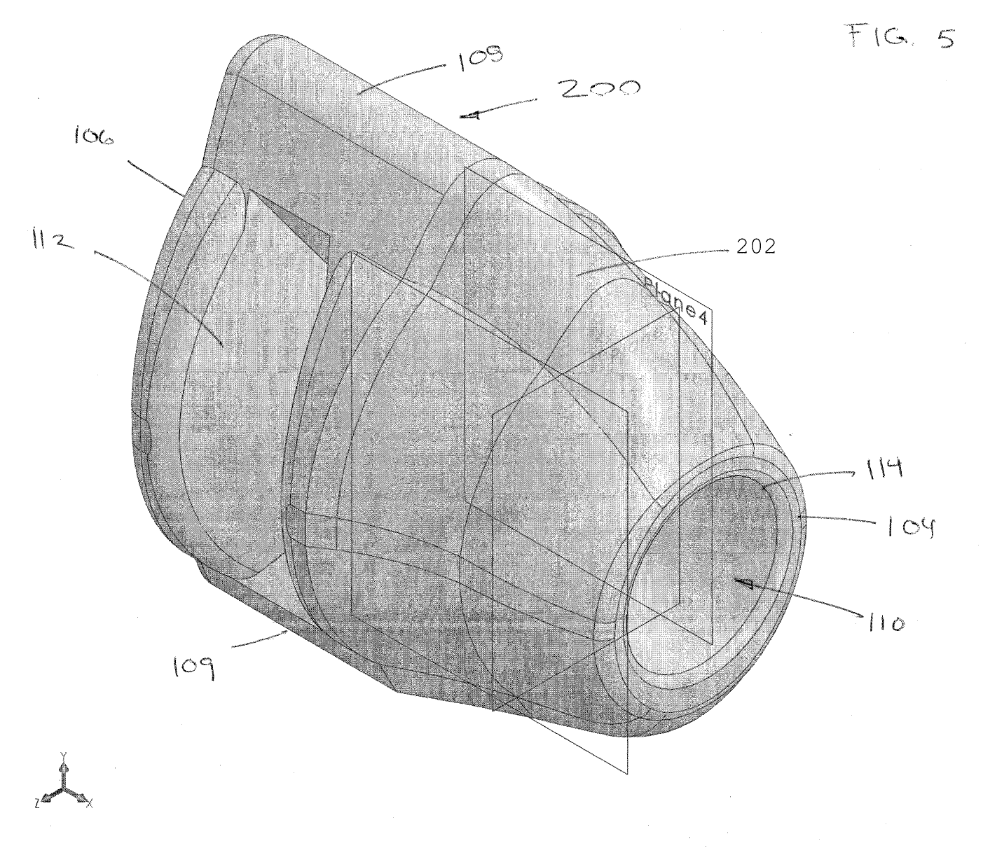

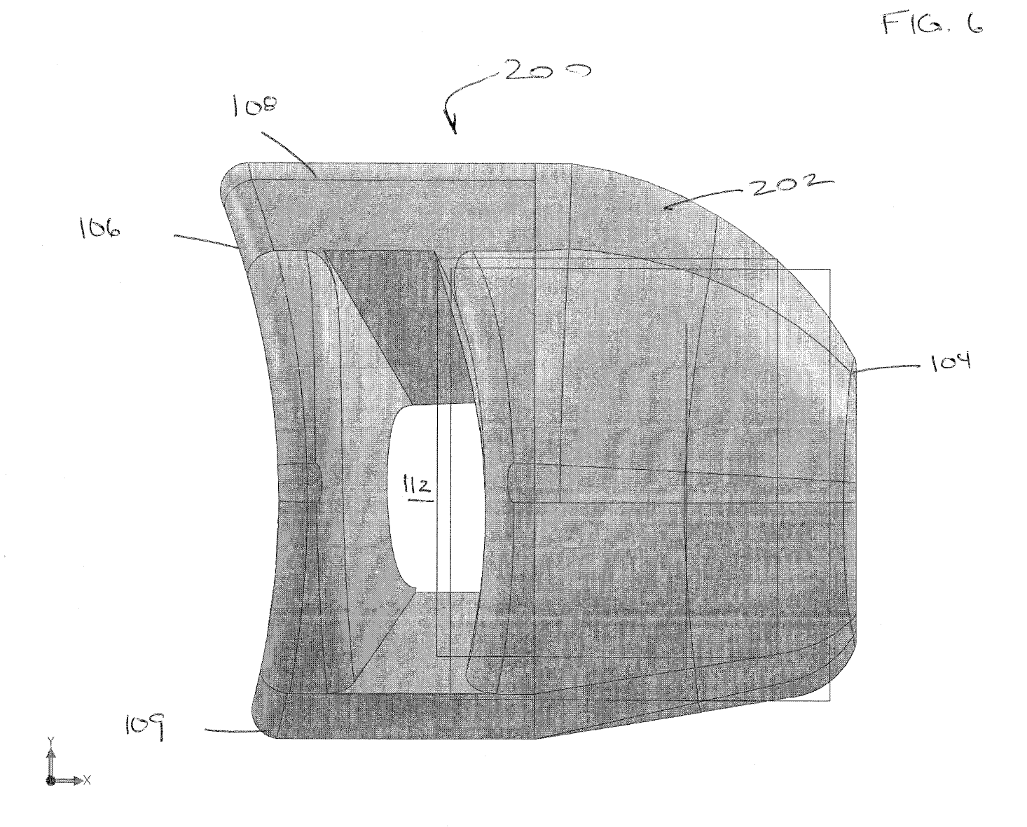

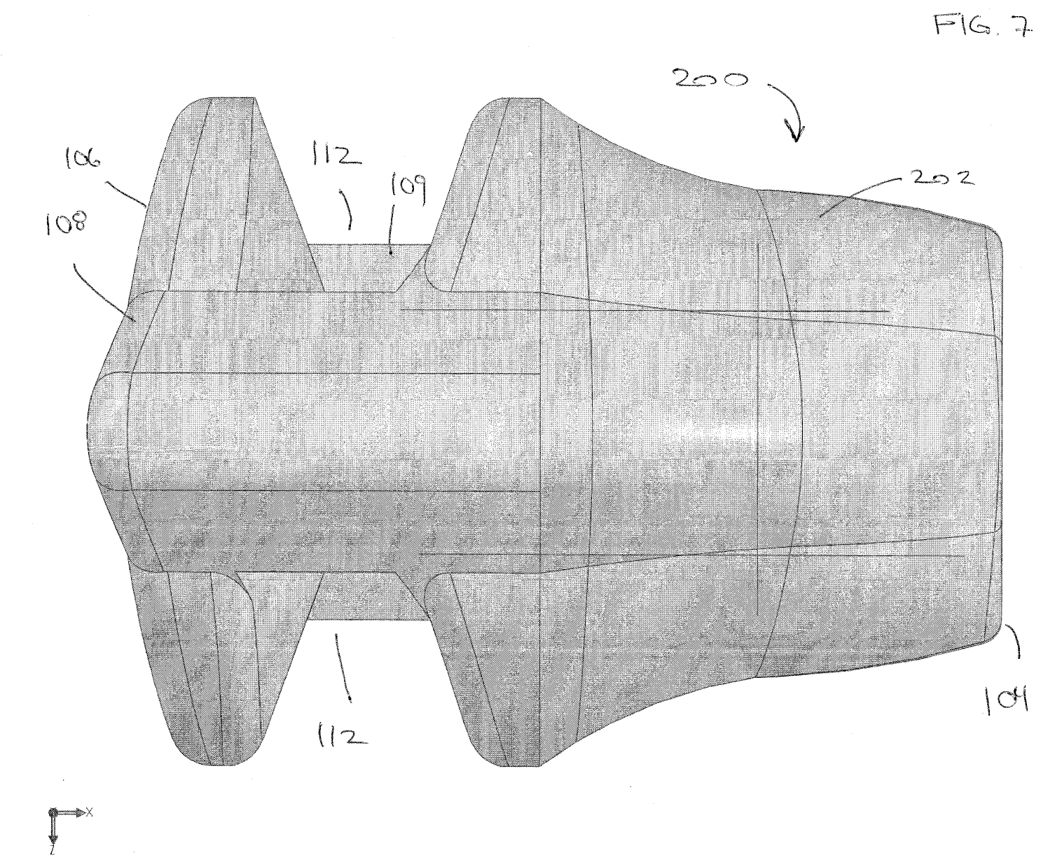

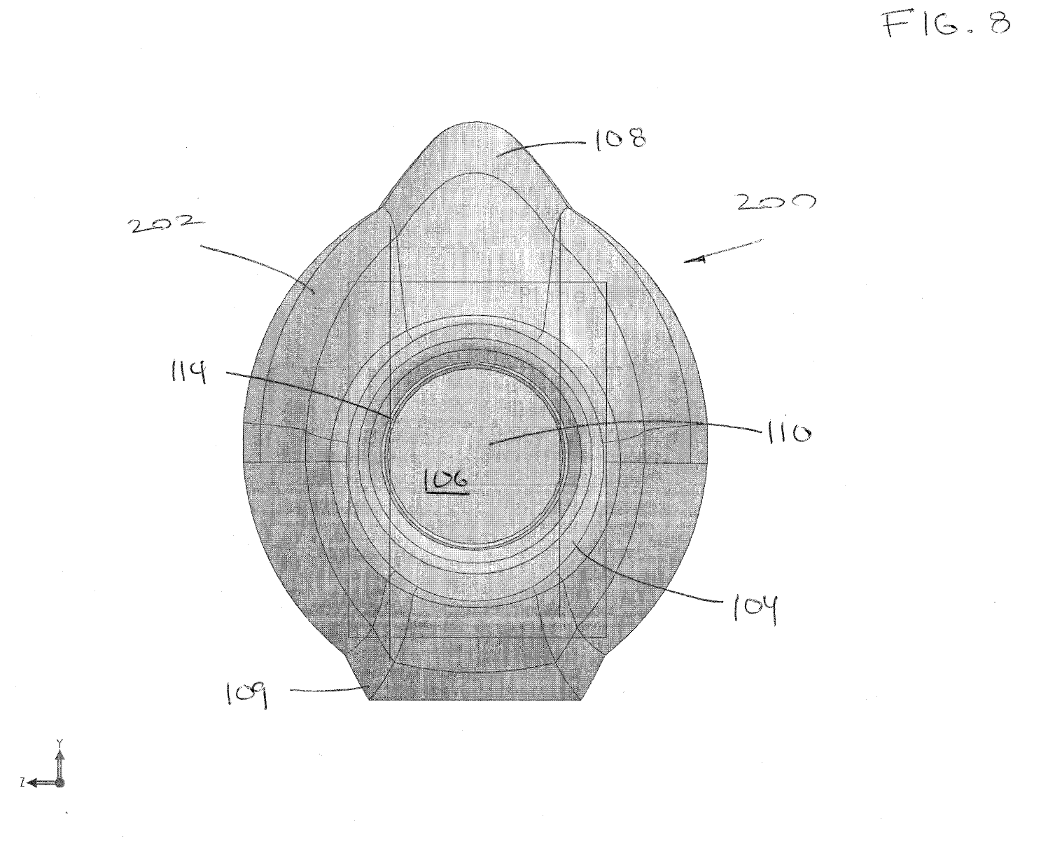

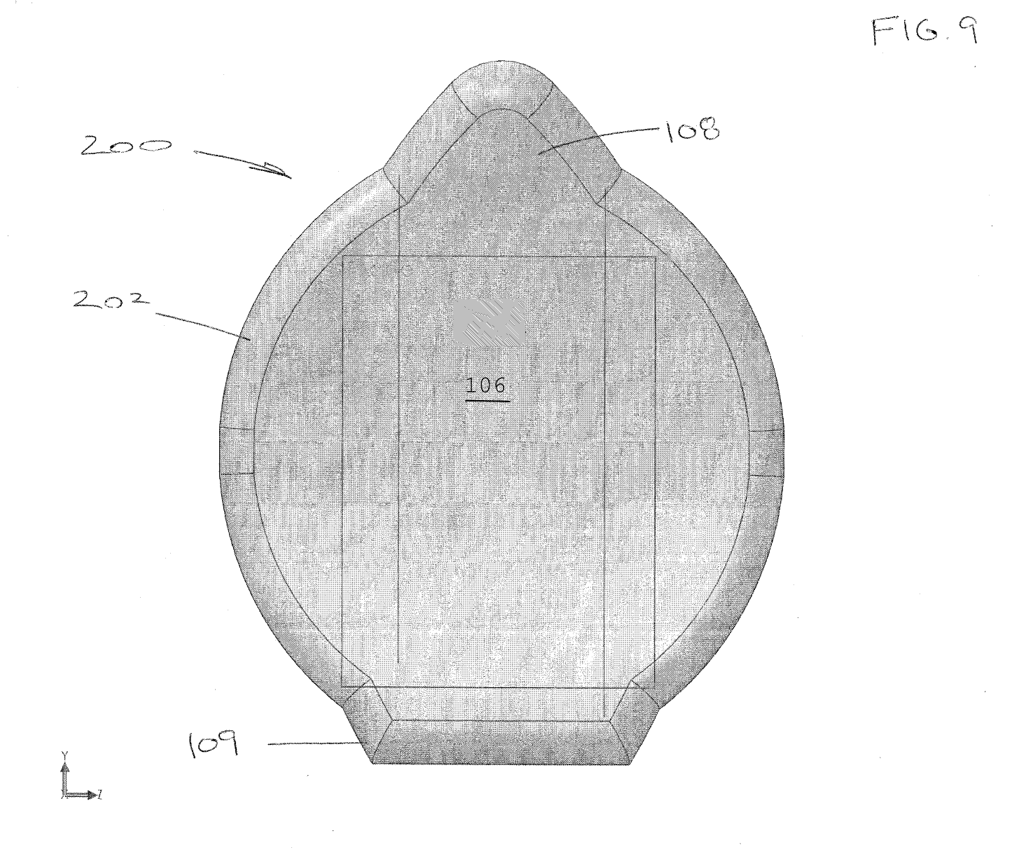

Referring now to FIGS. 5 to 9, a second embodiment of a fishing jig 200 with a body 202 according to the present disclosure is configured similarly to jig 100. The primary difference between jig 100 and jig 200 is the lack of an opening 111 through rear end 106 of jig 200. Any water entering shaft 110 of jig 200 will necessarily have to pass out through side openings 112. This change in water flow through the jig may be adapted as needed to alter the flow of water across any flexible rearward attachment or extension of jig 200 mounted adjacent to rear end 106. Without a rearward exit from shaft 110, water passing through the side openings 112 may provide jig 200 with a different movement through the water when in use.

It is anticipated that alternative embodiments may have one or more openings through rear end 106 or that there may be no openings for shaft 110 to extend end to end through jigs according to the present disclosure. Opening 111 through rear end 106 may be smaller or larger than shaft 110 as appropriate to create the desired water flow through and movement characteristics for a jig according to the present disclosure. It is further anticipated that two or more side openings may be provided in a jig according to the present disclosure for water to exit from shaft 110. Alternatively, it is anticipated that fewer openings may be provided within the scope of the present disclosure as well.

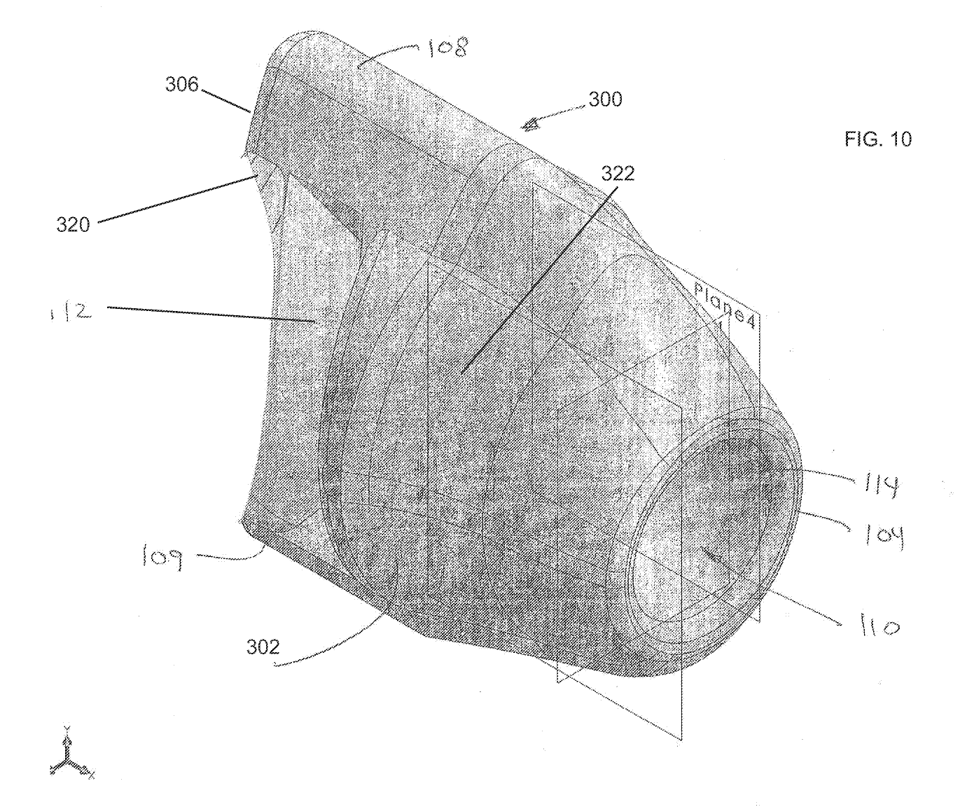

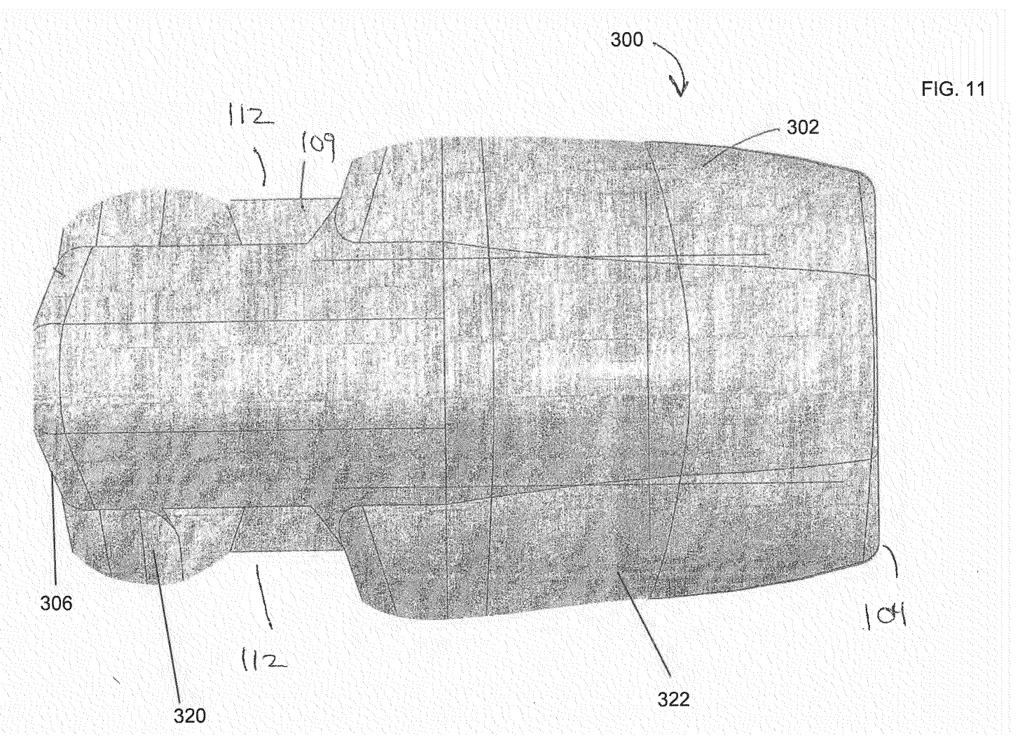

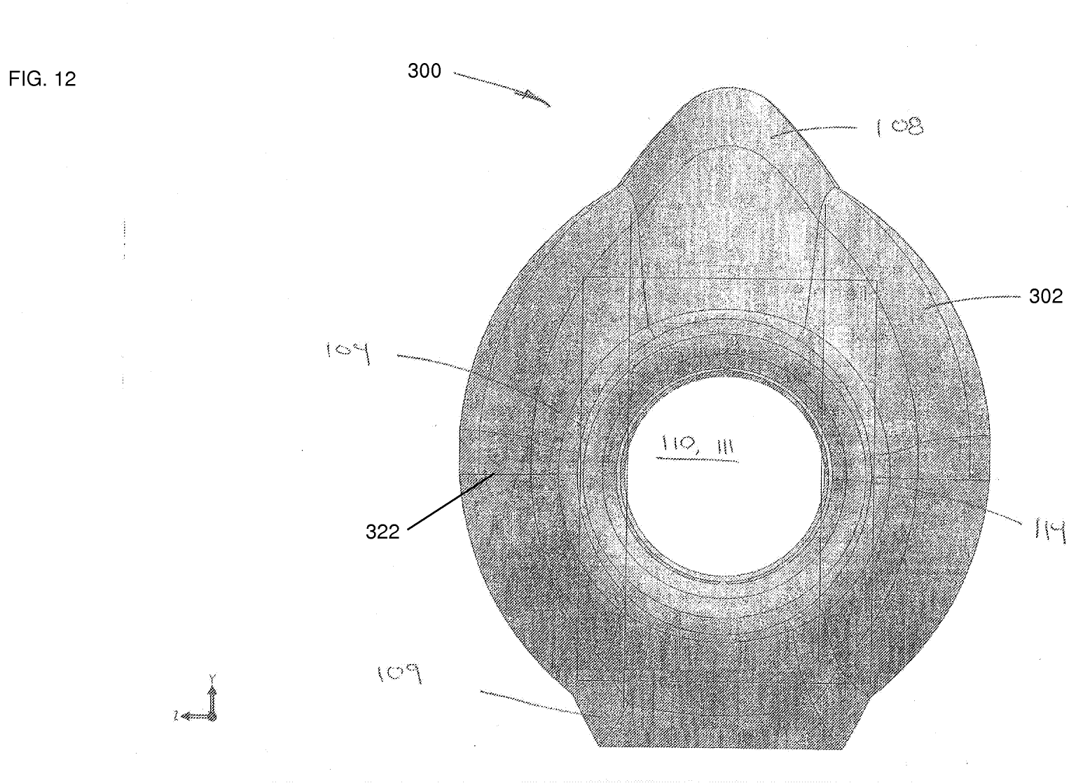

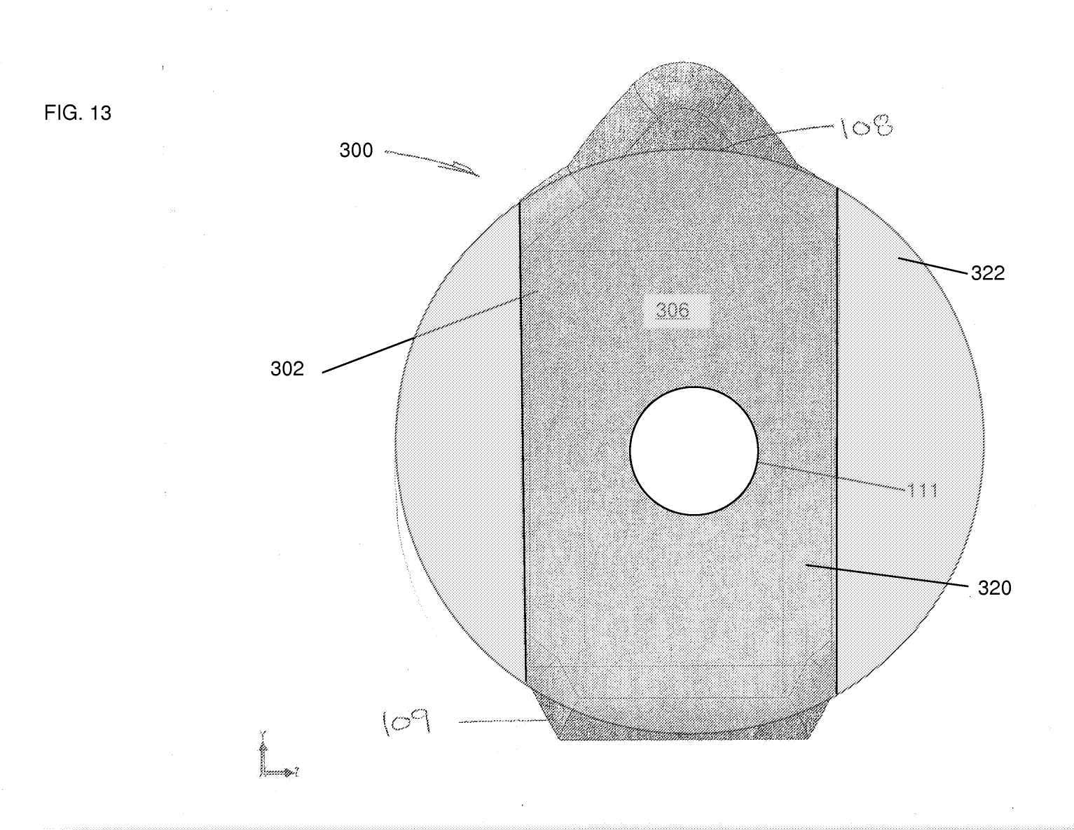

Referring now to FIGS. 10 to 13, a third alternative embodiment of a jig 300 is illustrated with a body 302 including a forward portion 322 between front end 104 and openings 109 and a rear portion 320 between a rear end 306 and openings 109. Rear portion 320 as shown is narrower or smaller in width than front portion 322. This shape may aid in the movement of jig 300 through the water and may improve the flow of water into opening 114 and through shaft 110. With the optional additional of a scent producing material or wick within shaft 110 or adjacent openings 109. Rear end 306 is illustrated with opening 111 extending shaft 110 through the length of body 302. It is anticipated that there may not be an opening through rear end 306 and that shaft 110 may terminate at openings 109.

While rear end 306 and rear portion 320 are illustrated as having straight or vertical sidewalls, this is intended as an illustrative example only. The shape of rear portion 320 may be any suitable shape that is narrower that front portion 322, and may be selected to optimize water flow out of openings 109, for the purpose of improving production efficiency, or for other reasons that may be obvious to a person having ordinary skill relative to the present disclosure.

It is anticipated that jigs 100 and 200 may be made or formed of lead according to any number of known casting, swaging or forging processes. It is not intended to limit the nature of the construction techniques that may be used to make or form jig bodies 102 and 202 according to the present disclosure. It is further anticipated that jigs 100 and 200 may be formed from other suitable materials or combinations of materials, provided the jigs are sufficiently dense to provide the desired sinking and movement characteristics when the jigs are in use in water.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. An improved fishing jig comprising:
a body with a front end and an opposite rear end;
an opening in the front end providing entry into a hollow shaft extending into the body;
one or more side openings extending from the hollow shaft out a side of the body;
the front opening and the one or more side openings cooperating to permit water entering the hollow shaft through the opening in the front to pass through the body of the jig and exit through the one or more side openings.

2. The improved fishing jig of claim 1, further comprising an opening extending through the rear end of the body and configured to permit water from the hollow shaft to flow out of the body through the rear end as the jig is worked through the water.

3. The improved fishing jig of claim 1, further comprising a scent producing material placed within the shaft and configured so that water passing through the shaft will carry scent from the scent producing material out the one or more side openings.

4. An improved fishing jig comprising:
a body with a front end and an opposite rear end;
an opening in the front end providing entry into a hollow shaft extending into the body;
one or more side openings extending from the hollow shaft out a side of the body;
a front portion of the body between the one or more side openings and the front end, and a rear portion between the one or more openings and the rear end, the rear portion substantially narrower that the front portion;
the front opening and the one or more side openings cooperating to permit water entering the hollow shaft through the opening in the front to pass through the body of the jig and exit through the one or more side openings.

5. The improved fishing jig of claim 4, further comprising an opening extending through the rear end of the body and configured to permit water from the hollow shaft to flow out of the body through the rear end as the jig is worked through the water.

6. The improved fishing jig of claim 4, further comprising a scent producing material placed within the shaft and configured so that water passing through the shaft will carry scent from the scent producing material out the one or more side openings.
